(19) United States
(12) Patent Application Publication
(10) Pub. No.: US 2018/0338160 A1
(43) Pub. Date: Nov. 22, 2018

(54) Method and Apparatus for Reduction of Artifacts in Coded Virtual-Reality Images

(71) Applicant: MEDIATEK INC., Hsin-Chu (TW)

(72) Inventors: Ya-Hsuan LEE, Hsinchu (TW); Jian-Liang LIN, Hsinchu (TW); Shen-Kai CHANG, Hsinchu (TW)

(21) Appl. No.: 15/976,313

(22) Filed: May 10, 2018

Related U.S. Application Data
(60) Provisional application No. 62/507,834, filed on May 18, 2017.

(51) Int. Cl. H04N 19/597; H04N 19/86; H04N 13/139; H04N 13/117; G06T 7/13; G06T 7/174

(52) U.S. Cl. CPC H04N 19/597; H04N 19/86; G06T 7/174; H04N 13/117; G06T 7/13; H04N 13/139

(57) ABSTRACT

Methods and apparatus of processing 360-degree virtual reality images are disclosed. According to one method, each 360-degree virtual reality image is projected into one first projection picture using first projection-format conversion. The first projection pictures are encoded and decoded into first reconstructed projection pictures. Each first reconstructed projection picture is then projected into one second reconstructed projection picture or one third reconstructed projection picture corresponding to a selected viewpoint using second projection-format conversion. One or more discontinuous edges in one or more second reconstructed projection pictures or one or more third reconstructed projection pictures corresponding to the selected viewpoint are identified. A post-processing filter is then applied to at least one discontinuous edge in the second reconstructed projection pictures or third reconstructed projection pictures corresponding to the selected viewpoint to generate filtered output.

### CROSS REFERENCE TO RELATED APPLICATIONS

The present invention claims priority to U.S. Provisional Patent Application, Ser. No. 62/507,834, filed on May 18, 2017. The U.S. Provisional Patent Application is hereby incorporated by reference in its entirety.

### FIELD OF THE INVENTION

The present invention relates to image processing for 360-degree virtual reality (VR) images. In particular, the present invention relates to reducing artifacts in coded VR images by using post-processing filtering.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a panoramic camera or a set of cameras arranged to capture 360-degree field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

The 360-degree virtual reality (VR) images may be captured using a 360-degree spherical panoramic camera or multiple images arranged to cover all filed of views around 360 degrees. The three-dimensional (3D) spherical image is difficult to process or store using the conventional image/video processing devices. Therefore, the 360-degree VR images are often converted to a two-dimensional (2D) format using a 3D-to-2D projection method. For example, equirectangular projection (ERP) and cubemap projection (CMP) have been commonly used projection methods. Accordingly, a 360-degree image can be stored in an equirectangular projected format. The equirectangular projection maps the entire surface of a sphere onto a flat image. The vertical axis is latitude and the horizontal axis is longitude. FIG. 1A illustrates an example of projecting a sphere 110 into a rectangular image 120 according to equirectangular projection, where each longitude line is mapped to a vertical line of the ERP picture. FIG. 1B illustrates an example of ERP picture 130. For the ERP projection, the areas in the north and south poles of the sphere are stretched more severely (i.e., from a single point to a line) than areas near the equator. Furthermore, due to distortions introduced by the stretching, especially near the two poles, predictive coding tools often fail to make good prediction, causing reduction in coding efficiency. FIG. 2 illustrates a cube 210 with six faces, where a 360-degree virtual reality (VR) image can be projected to the six faces on the cube according to cubemap projection. There are various ways to lift the six faces off the cube and repack them into a rectangular picture. The example shown in FIG. 2 divides the six faces into two parts (220a and 220b), where each part consists of three connected faces. The two parts can be unfolded into two strips (230a and 230b), where each strip corresponds to a continuous picture. The two strips can be joined to form a rectangular picture 240 according to one CMP layout as shown in FIG. 2. However, the layout is not very efficient since some blank areas exist. Accordingly, a compact layout 250 is used, where a boundary 252 is indicated between the two strips (250a and 250b). However, the picture contents are continuous within each strip.

Besides the ERP and CMP formats, there are various other VR projection formats, such as octahedron projection (OHP), icosahedron projection (ISP), segmented sphere projection (SSP) and rotated sphere projection (RSP), that are widely used in the field.

FIG. 3A illustrates an example of octahedron projection (OHP), where a sphere is projected onto faces of an 8-face octahedron 310. The eight faces 320 lifted from the octahedron 310 can be converted to an intermediate format 330 by cutting open the face edge between faces 1 and 5 and rotating faces 1 and 5 to connect to faces 2 and 6 respectively, and applying a similar process to faces 3 and 7. The intermediate format can be packed into a rectangular picture 340. FIG. 3B illustrates an example of octahedron projection (OHP) picture 350, where discontinuous face edges 352 and 354 are indicated. As shown in layout format 340, discontinuous face edges 352 and 354 correspond to the shared face edge between face 1 and face 5 as shown in layout 320.

FIG. 4A illustrates an example of icosahedron projection (ISP), where a sphere is projected onto faces of a 20-face icosahedron 410. The twenty faces 420 from the icosahedron 410 can be packed into a rectangular picture 430 (referred as a projection layout), where the discontinuous face edges are indicated by thick dashed lines 432. An example of the converted rectangular picture 440 via the ISP is shown in FIG. 4B, where the discontinuous face boundaries are indicated by white dashed lines 442.

Segmented sphere projection (SSP) has been disclosed in JVET-E0025 (Zhang et al., “AHG8: Segmented Sphere Projection for 360-degree video”, Joint Video Exploration Team (WET) of ITU-T SG 16 WP 3 and ISO/IEC JTC 1/SC 29/WG 11, 5th Meeting: Geneva, CH, 12-20 Jan. 2017, Document: WET-E0025) as a method to convert a spherical image into an SSP format. FIG. 5A illustrates an example of segmented sphere projection, where a spherical image 500 is mapped into a North Pole image 510, a South Pole image 520 and an equatorial segment image 530. The boundaries of 3 segments correspond to latitudes 45° N (502) and 45° S (504), where 0° corresponds to the equator (506). The North and South Poles are mapped into 2 circular areas (i.e., 510 and 520), and the projection of the equatorial segment can be the same as ERP or equal-area projection (EAP). The diameter of the circle is equal to the width of the equatorial segments because both Pole segments and equatorial segment have a 90° latitude span. The North Pole image 510, South Pole image 520 and the equatorial segment image 530 can be packed into a rectangular image 540 as shown in an example in FIG. 5B, where discontinuous boundaries 542, 544 and 546 between different segments are indicated.

FIG. 5C illustrates an example of rotated sphere projection (RSP), where the sphere 550 is partitioned into a middle 270°×90° region 552, and a residual part 554. These two parts of RSP can be further stretched on the top side and the bottom side to generate a deformed part 556 having oval-shaped boundaries 557 and 558 on the top part and bottom part as indicated by the dashed lines. FIG. 5D illustrates an example of RSP picture 560, where discontinuous boundaries 562 and 564 between two rotated segments are indicated by dashed lines.

Since the images or video associated with virtual reality may take a lot of space to store or a lot of bandwidth to transmit, therefore image/video compression is often used to reduce the required storage space or transmission bandwidth. However, when the three-dimensional (3D) virtual reality image is converted to a two-dimensional (2D) picture, some boundaries between faces may exist in the packed pictures via various projection methods. For example, a horizontal boundary 252 exists in the middle of the converted picture 250 according to the CMP in FIG. 2. Boundaries between faces also exist in converted pictures by other projection methods as shown in FIG. 3 through FIG. 5. As is known in the field, image/video coding usually results in some distortions between the original image/video and reconstructed image/video, which manifest visible artifacts in the reconstructed image/video. FIG. 6 illustrates an example of artifacts in a reconstructed picture for a selected viewpoint from CMP, where a faint seam artifact 610 due to the discontinuous edges in the layout is visible. Dashed-line ellipse 620 is used to highlight the area around the visible seam artifacts.

### BRIEF SUMMARY OF THE INVENTION

Methods and apparatus of processing 360-degree virtual reality images are disclosed. According to one method, each 360-degree virtual reality image is projected into one first projection picture using first projection-format conversion. The first projection pictures are encoded and decoded into first reconstructed projection pictures. Each first reconstructed projection picture is then projected into one second reconstructed projection picture or one third reconstructed projection picture corresponding to a selected viewpoint using second projection-format conversion. One or more discontinuous edges in one or more second reconstructed projection pictures or one or more third reconstructed projection pictures corresponding to the selected viewpoint are identified. A post-processing filter is then applied to at least one discontinuous edge in the second reconstructed projection pictures or third reconstructed projection pictures corresponding to the selected viewpoint to generate filtered output.

The post-processing filter may belong to a group comprising low-pass filter, mean filter, deblocking filter, non-local mean filter, convolutional neural network (CNN), and deep learning filter. The 360-degree virtual reality images may be in an ERP (Equirectangular Projection) format.

The first projection-format conversion may belong to a group comprising ERP (Equirectangular Projection), CMP (Cubemap Projection), OHP (Octahedron Projection), ISP (Icosahedron Projection), SSP (Segmented Sphere Projection), RSP (Rotated Sphere Projection) and identity conversion. When the first projection-format conversion corresponds to the ERP, the discontinuous edge is associated with a left boundary and a right boundary of one first reconstructed projection picture. When the first projection-format conversion corresponds to the CMP, OHP or ISP, said at least one discontinuous edge is associated with a shared face edge on a respective cube, octahedron or icosahedron in one first reconstructed projection picture and the shared face edge is projected to different edges in the first reconstructed projection picture. When the first projection-format conversion corresponds to the SSP, the discontinuous edge is associated with picture boundary between a north-pole image and an equatorial segment image or between a south-pole image and the equatorial segment image in the first reconstructed projection picture.

The second projection-format conversion may belong to a group comprising ERP (Equirectangular Projection), CMP (Cubemap Projection), OHP (Octahedron Projection), ISP (Icosahedron Projection), SSP (Segmented Sphere Projection), and RSP (Rotated Sphere Projection).

According to another method, the process starts with receiving one or more first reconstructed projection pictures or one or more second reconstructed projection pictures corresponding to a selected viewpoint, where the first reconstructed projection pictures or the second reconstructed projection pictures correspond to one or more encoded and decoded projection pictures in another projection format. The remaining process regarding identifying discontinuous edges and applying post-processing filter is the same as the previous method.

### BRIEF DESCRIPTION OF THE DRAWINGS

FIG. 1A illustrates an example of projecting a sphere into a rectangular image according to equirectangular projection, where each longitude line is mapped to a vertical line of the ERP picture.

FIG. 1B illustrates an example of ERP picture.

FIG. 2 illustrates a cube with six faces, where a 360-degree virtual reality (VR) image can be projected to the six faces on the cube according to cubemap projection.

FIG. 3A illustrates an example of octahedron projection (OHP), where a sphere is projected onto faces of an 8-face octahedron.

FIG. 3B illustrates an example of octahedron projection (OHP) picture, where discontinuous face edges are indicated.

FIG. 4A illustrates an example of icosahedron projection (ISP), where a sphere is projected onto faces of a 20-face icosahedron.

FIG. 4B illustrates an example of icosahedron projection (ISP) picture, where the discontinuous face boundaries are indicated by white dashed lines 442.

FIG. 5A illustrates an example of segmented sphere projection (SSP), where a spherical image is mapped into a North Pole image, a South Pole image and an equatorial segment image.

FIG. 5B illustrates an example of segmented sphere projection (SSP) picture, where discontinuous boundaries between different segments are indicated.

FIG. 5C illustrates an example of rotated sphere projection (RSP), where the sphere is partitioned into a middle 270°×90° region and a residual part. These two parts of RSP can be further stretched on the top side and the bottom side to generate deformed parts having oval-shaped boundary on the top part and bottom part.

FIG. 5D illustrates an example of rotated sphere projection (RSP) picture, where discontinuous boundaries between different segments are indicated.

FIG. 6 illustrates an example of artifacts in a reconstructed picture for a viewpoint from CMP.

FIG. 7 illustrates an exemplary block diagram of a system incorporating the post-processing filtering to alleviate the artifacts due to the discontinuous edges in a converted picture.

FIG. 8 illustrates an example of discontinuous edge in a reconstructed picture using the ERP format.

FIG. 9 illustrates an example of discontinuous edge in a reconstructed picture using a CMP format.

FIG. 10 illustrates an example of discontinuous edge in a reconstructed picture using an OHP format.

FIG. 11 illustrates an example of discontinuous edge in a reconstructed picture using an ISP format.

FIG. 12A illustrates an example of discontinuous edge in a reconstructed picture using an SSP format.

FIG. 12B illustrates an example of discontinuous edge in a reconstructed picture using an RSP format.

FIG. 13 illustrates an exemplary flowchart of a system that applies post-processing filter to reconstructed projection images according to an embodiment of the present invention.

FIG. 14 illustrates another exemplary flowchart of a system that applies post-processing filter to reconstructed projection images according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned above, artifacts in a reconstructed projection picture may exist due to the discontinuous edges and the boundaries in a converted picture using various 3D-to-2D projection methods. In FIG. 6, an example of artifacts in a reconstructed picture for a viewpoint from CMP is illustrated.

In order to alleviate the artifacts in the reconstructed VR image/video, post filtering is applied to the reconstructed VR image/video according to embodiments of the present invention. Various post-processing filters such as a low-pass filter, mean filter, deblocking filter, non-local mean filter, convolutional neural network (CNN), and deep learning filter can be used to reduce the artifacts.

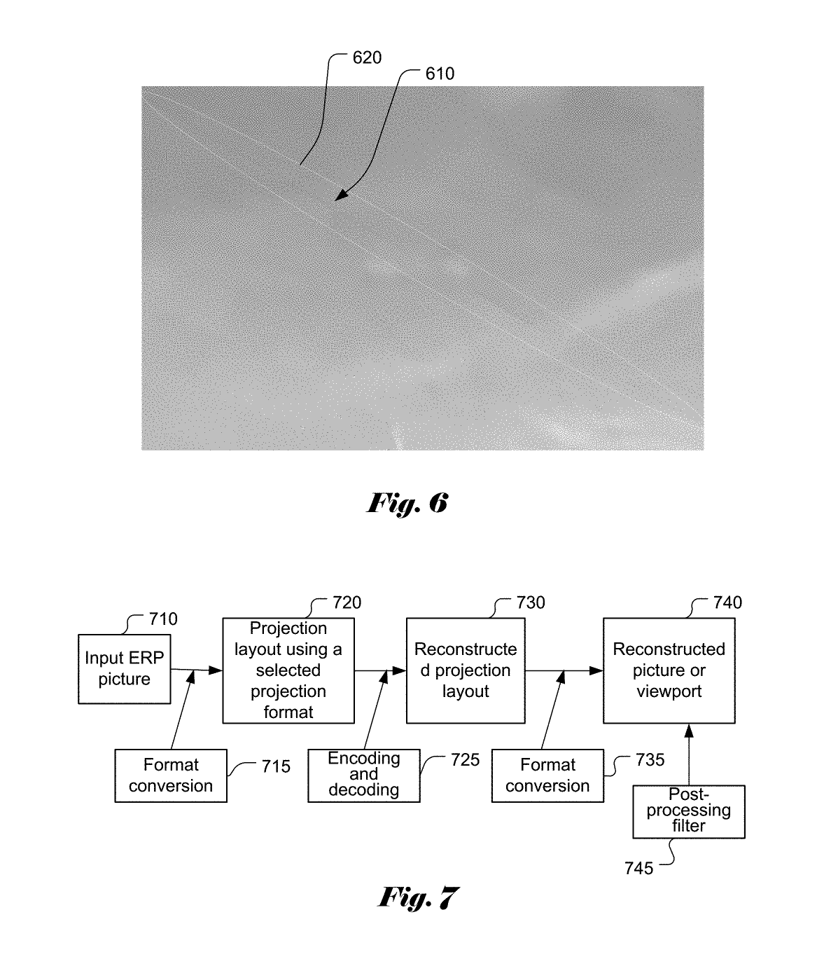

The post-processing filtering is applied to the reconstructed VR image/video. An exemplary block diagram of a system incorporating the post-processing filtering to alleviate the artifacts due to the discontinuous edges in a converted picture is illustrated in FIG. 7. In the example of FIG. 7, an input ERP picture 710 is converted into a projection layout corresponding to a selected projection format 720. A projection-format conversion process 715 is used to perform the conversion. Encoding and decoding process 725 is then applied to the projection layout 720 to generate the reconstructed projection layout 730. Another format conversion process 735 is applied to the reconstructed projection layout 730 to convert it to a reconstructed picture or viewpoint 740. The post-processing filter 745 according to the present invention is then applied to the reconstructed picture or viewpoint 740. While ERP pictures are used as the input picture format, other VR image formats may also be used.

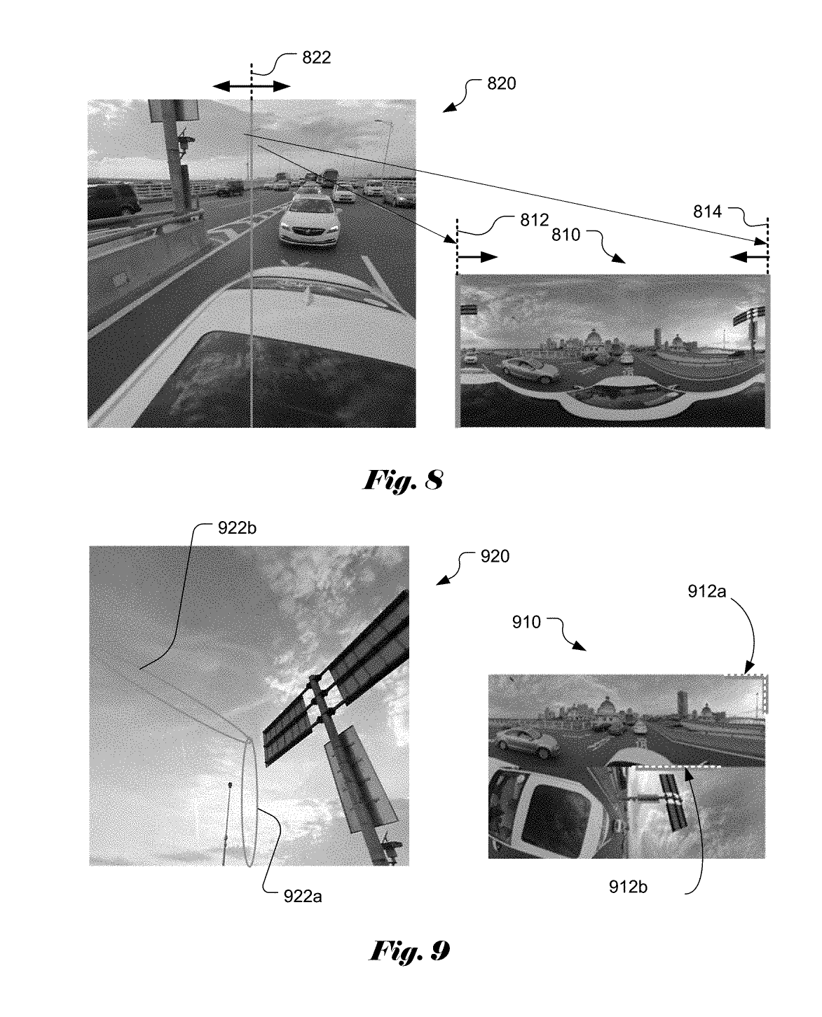

FIG. 8 illustrates an example of discontinuous edge in a reconstructed picture in the ERP format. The ERP picture 810 has contents flowing continuously from the left edge 812 to the right edge 814 of the ERP picture. The contents on the right edge 814 flow into the left edge 812 of the ERP picture. In other words, the ERP picture is wrapped around the left-right edges. However, a standard image or video coder does not take this fact into consideration. Therefore, more coding distortion may occur around the left edge and the right edge. When the reconstructed picture or the reconstructed viewpoint is displayed, the areas corresponding to the left edge and the right edge may show more noticeable artifacts. For example, a reconstructed picture 820 corresponding to a selected viewpoint can be displayed, where the areas around the edge boundary may be very noticeable. The left edge 812 and right edge 814 are mapped to line 822 of converted reconstructed picture 820. The area from line 822 toward the right side of picture 820 corresponds to the area from line 812 toward the right side of picture 810. The area from line 822 toward the left side of picture 820 corresponds to the area from line 814 toward the left side of picture 810. After reconstruction, the larger distortion around the left edge 812 and the right edge 814 of picture 810 manifest noticeable artifacts around line 822 of picture 820. Accordingly, a post-processing filter is applied to areas around line 822 (including line 822) according to the present invention. The post-processing filter can be selected from a group comprising a low-pass filter, mean filter, deblocking filter, non-local mean filter, convolutional neural network (CNN), and deep learning filter.

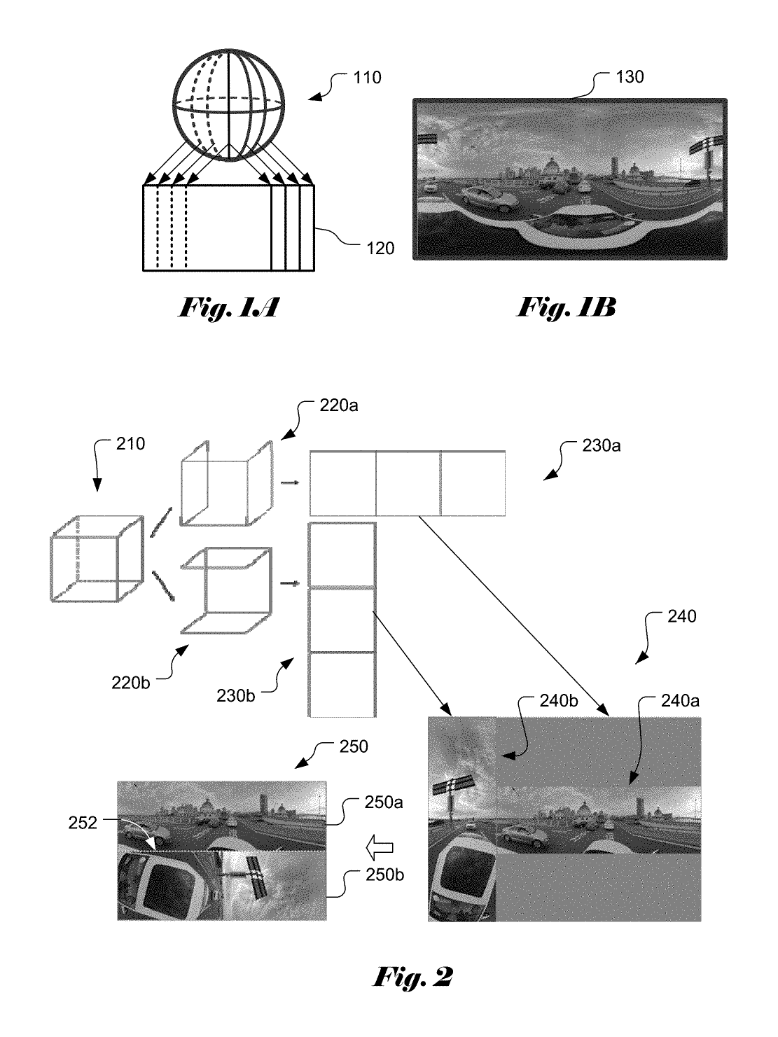

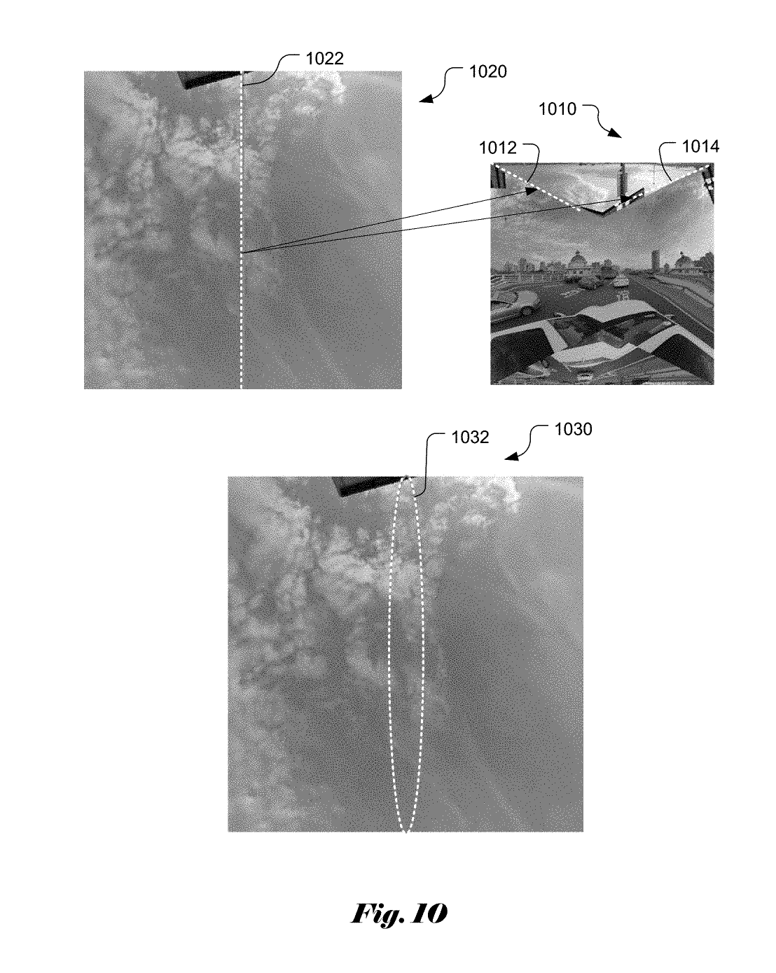

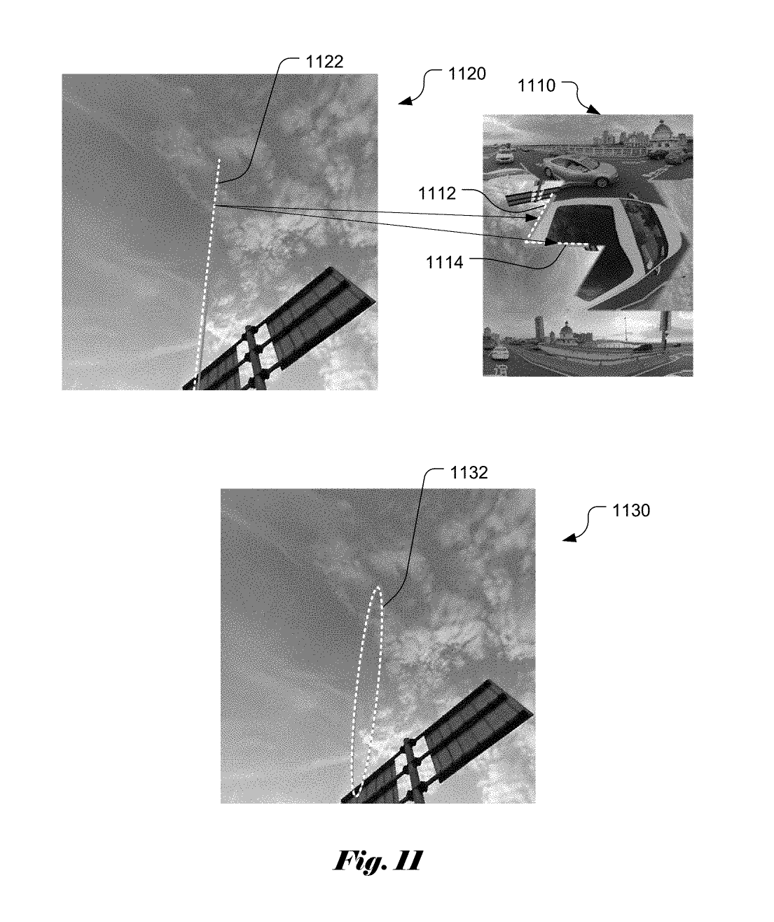

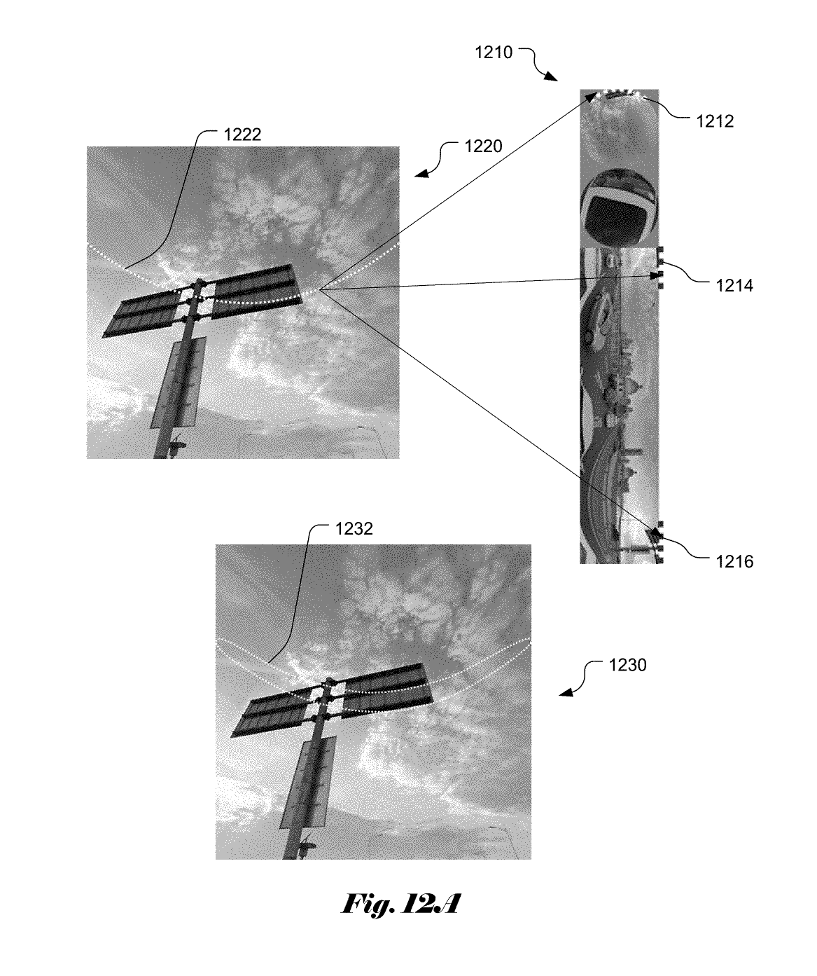

FIG. 9 illustrates an example of discontinuous edge in a reconstructed picture in a CMP format. The CMP picture 910 corresponds to the CMP picture 250 generated according to the conversion process of FIG. 2. The upper right corner 912a of CMP picture 910 corresponds to face edges of one cube face, which share the same face edges 912b with another two faces of cube as indicated by line segment 912b in the middle of CMP picture 910. Picture 920 corresponds to a converted reconstructed viewpoint based on a coded picture of CMP picture 910. The shared face edges (912a, 912b) are mapped to boundary lines as indicated by ellipses 922a and 922b in FIG. 9. Due to discontinuities around the face edges 912a and 912b, artifacts become more noticeable around boundaries of the reconstructed viewpoint. Accordingly, a post-processing filter is applied to areas around lines 922a and 922b (including lines 922a and 922b) according to the present invention. Again, the post-processing filter can be selected from a group comprising a low-pass filter, mean filter, deblocking filter, non-local mean filter, convolutional neural network (CNN), and deep learning filter.

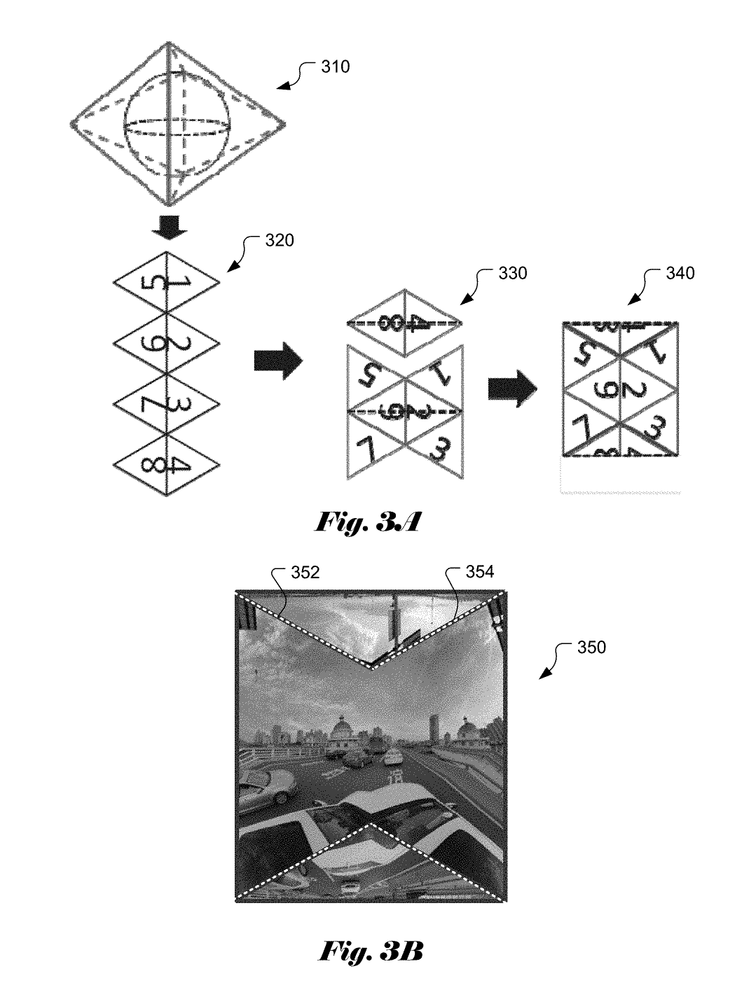

FIG. 10 illustrates an example of discontinuous edge in a reconstructed picture in an OHP format. The OHP picture 1010 corresponds to the OHP picture 350 in FIG. 3B generated according to the conversion process of FIG. 3A. The face boundaries 1012 and 1014 are discontinuous in OHP picture 1010. Therefore, a coded OHP picture may show more noticeable artifacts at and around face boundaries 1012 and 1014. Picture 1020 corresponds to a reconstructed or rendered picture or viewport output, and the shared face edge 1022 in the reconstructed or rendered picture or viewport output is indicated. Due to discontinuities around the face edges 1012 and 1014, artifacts become more noticeable around line 1022 of the reconstructed viewpoint. Accordingly, a post-processing filter is applied to areas around line 1022 (including line 1022). In order to make the artifacts visible, the line 1022 is taken out and the area of artifacts is indicated by ellipse 1032 in picture 1030.

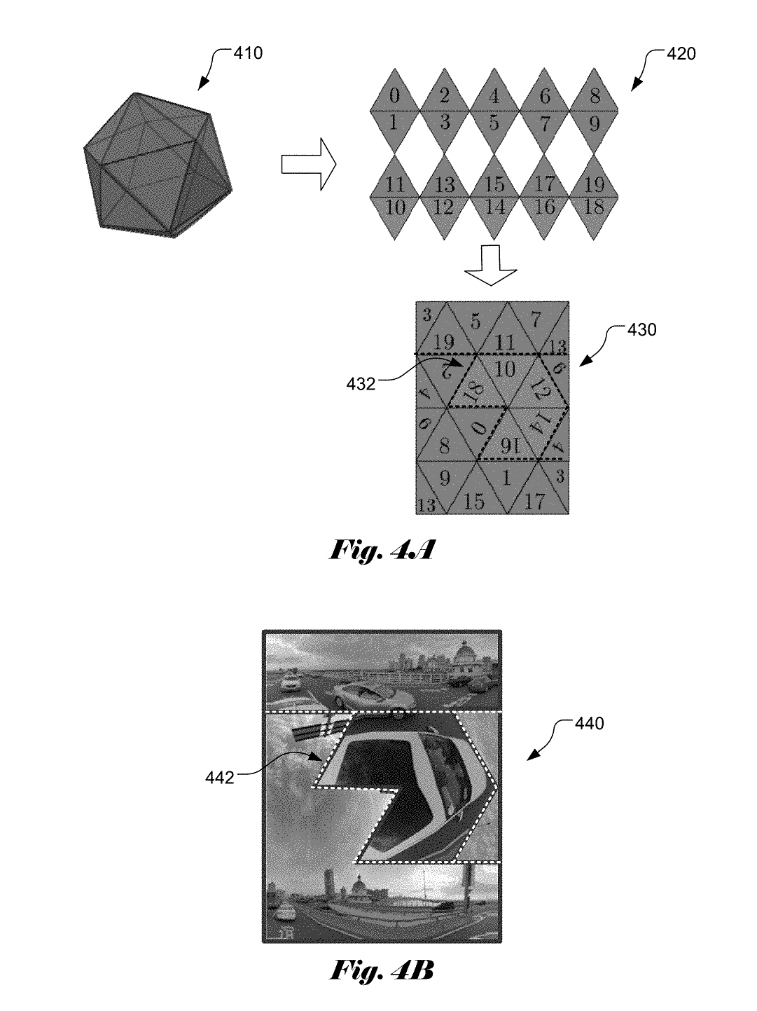

FIG. 11 illustrates an example of discontinuous edge in a reconstructed picture in an ISP format. The ISP picture 1110 corresponds to the ISP picture 440 in FIG. 4B generated according to the conversion process of FIG. 4A. The face boundaries 1112 and 1114 are discontinuous in ISP picture 1110. Therefore, a coded ISP picture may show more noticeable artifacts at and around face boundaries 1112 and 1114. As shown in FIG. 4A, face boundaries 1112 and 1114 correspond to a shared face edge between face 2 and face 0 as evidenced in layouts 420 and 430. Picture 1120 corresponds to a reconstructed or rendered picture or viewport output, the shared face edge 1122 in the reconstructed or rendered picture or viewport output is indicated. Due to discontinuities around the face edges 1112 and 1114, artifacts become more noticeable around line 1122 of the reconstructed viewpoint. Accordingly, a post-processing filter is applied to areas around line 1122 (including line 1122). In order to make the artifacts visible, the line 1122 is taken out and the area of artifacts is indicated by ellipse 1132 in picture 1130.

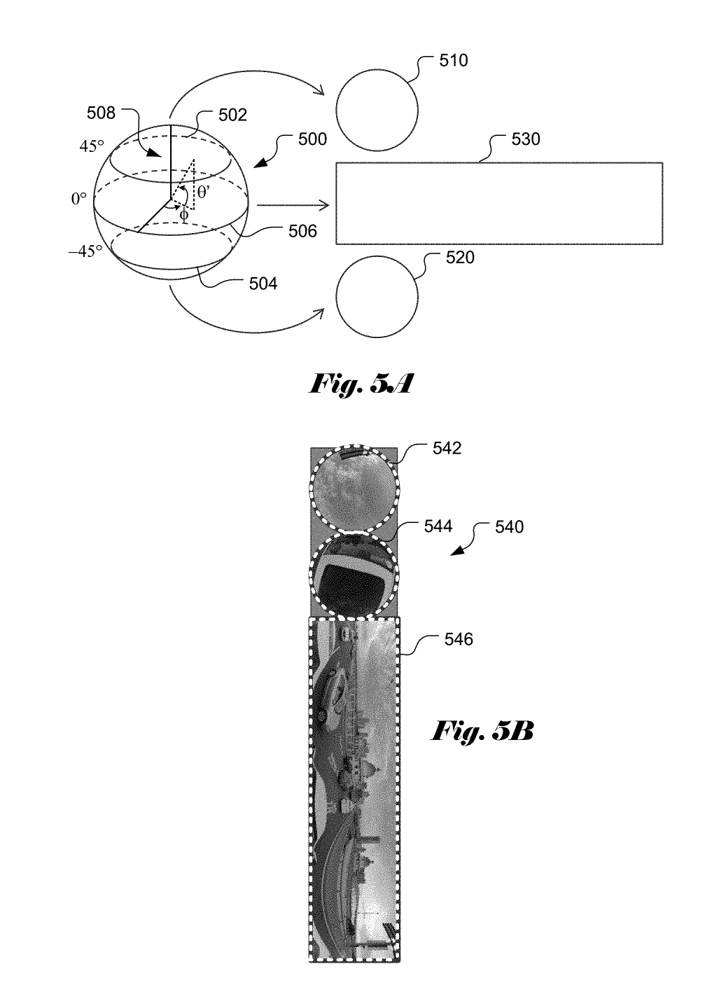

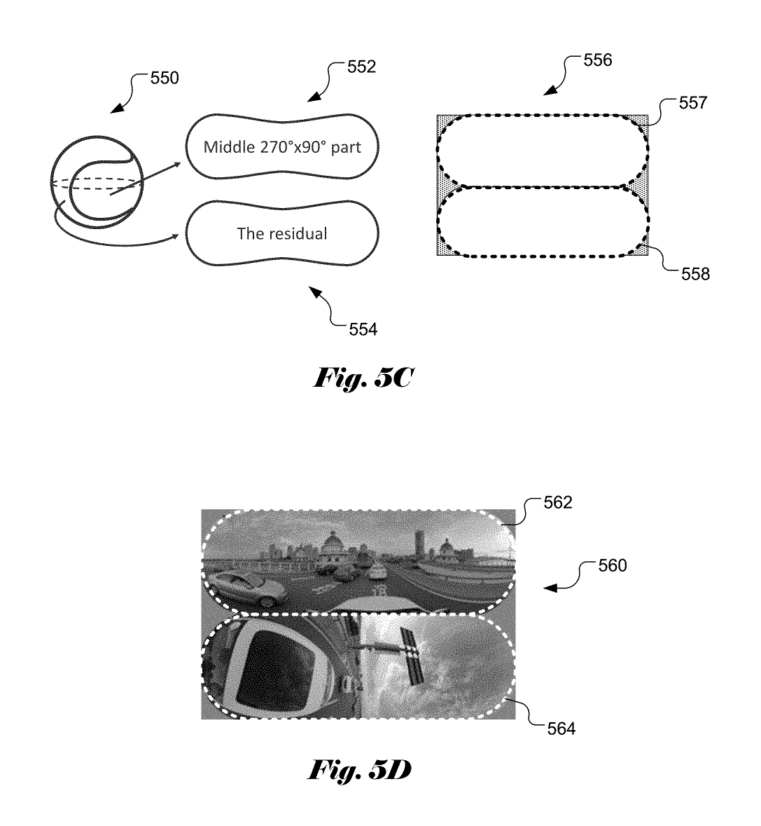

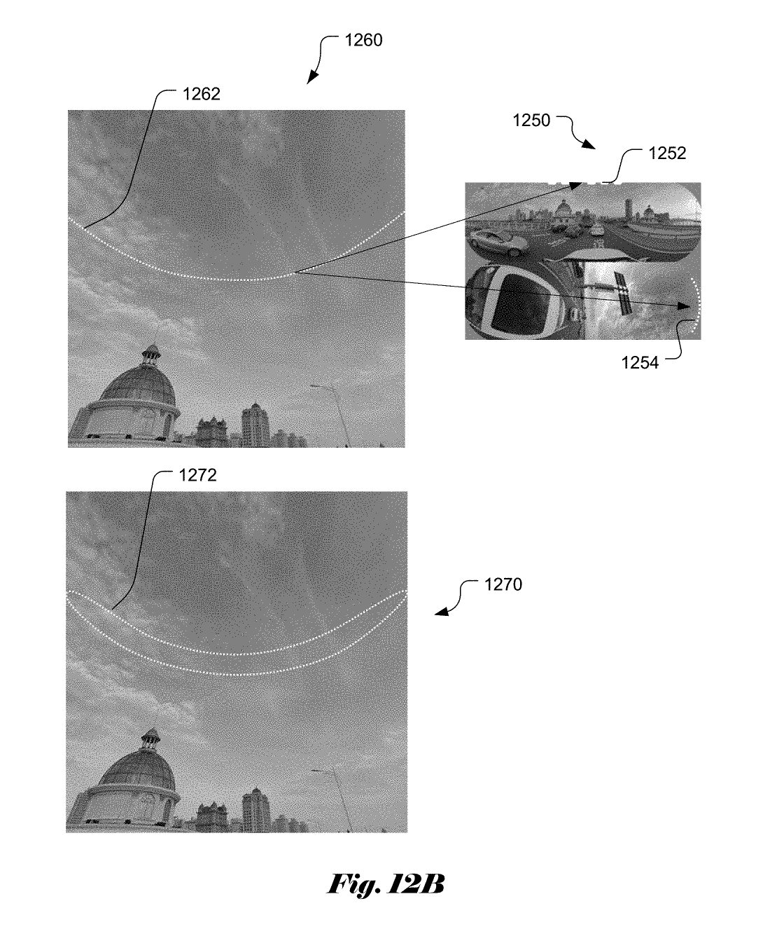

FIG. 12A illustrates an example of discontinuous edge in a reconstructed picture in an SSP format. The SSP picture 1210 corresponds to the SSP picture 540 in FIG. 5B generated according to the conversion process of FIG. 5A. The boundaries 1212, 1214 and 1216 among segments are discontinuous in SSP picture 1210. Therefore, a coded SSP picture may show more noticeable artifacts at and around face boundaries 1212, 1214 and 1216. Picture 1220 corresponds to a reconstructed or rendered picture or viewport output, the shared segment boundary 1222 in the reconstructed or rendered picture or viewport output is indicated. Due to discontinuities around the segment boundaries 1212, 1214 and 1216, artifacts become more noticeable around line 1222 of the reconstructed viewpoint 1220. Accordingly, a post-processing filter is applied to areas around line 1222 (including line 1222). In order to make the artifacts visible, the line 1222 is taken out and the area 1232 of artifacts is indicated in picture 1230.

FIG. 12B illustrates an example of discontinuous edge in a reconstructed picture in an RSP format. The RSP picture 1250 corresponds to the RSP picture 560 in FIG. 5D generated according to the conversion process of FIG. 5C. The boundaries 1252 and 1254 among segments are discontinuous in RSP picture 1250. Therefore, a coded RSP picture may show more noticeable artifacts at and around boundaries 1252 and 1254. Picture 1260 corresponds to a reconstructed or rendered picture or viewport output, the shared segment boundary 1262 in the reconstructed or rendered picture or viewport output is indicated. Due to discontinuities around the segment boundaries 1252 and 1254, artifacts become more noticeable around line 1262 of the reconstructed viewpoint 1260. Accordingly, a post-processing filter is applied to areas around line 1262 (including line 1262). In order to make the artifacts visible, the line 1262 is taken out and the area 1272 of artifacts is indicated in picture 1270.

An exemplary block diagram of a system incorporating the post-processing filtering to alleviate the artifacts due to the discontinuous edges in a converted picture is illustrated in FIG. 7. In this example, the input 3D image format corresponds to an ERP picture. Nevertheless, other 360-degree VR format, such as a spherical format, may also be used. When the ERP format is used as an input format and the ERP picture is used as the projection layout 720 for encoding and decoding, the format conversion 715 corresponds to an identity conversion. In other words, no format conversion is needed.

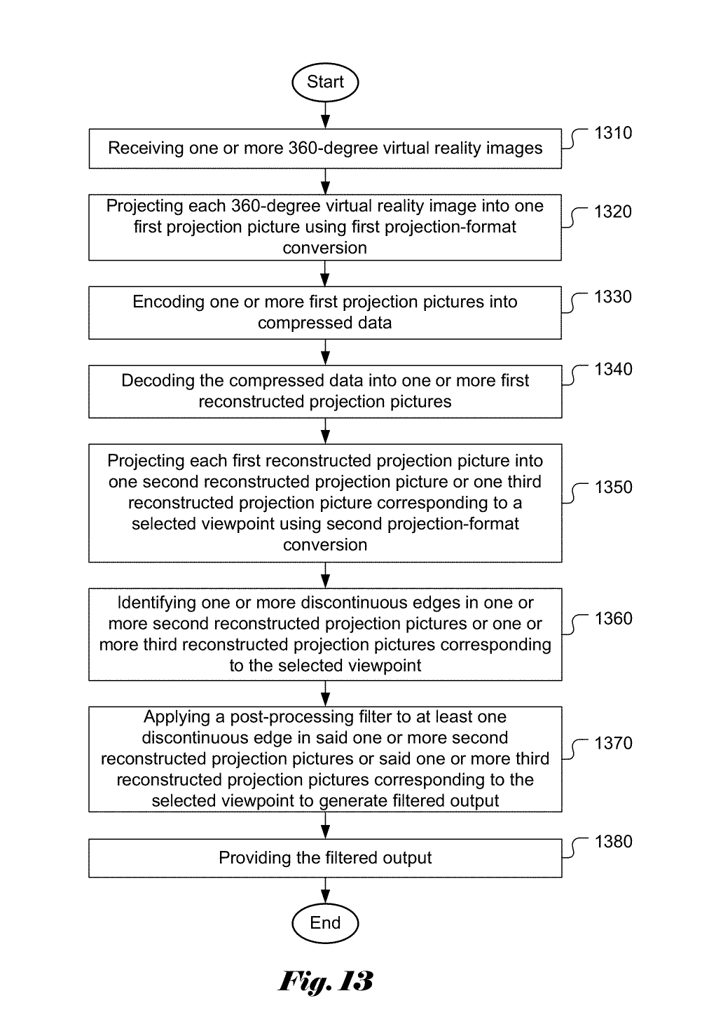

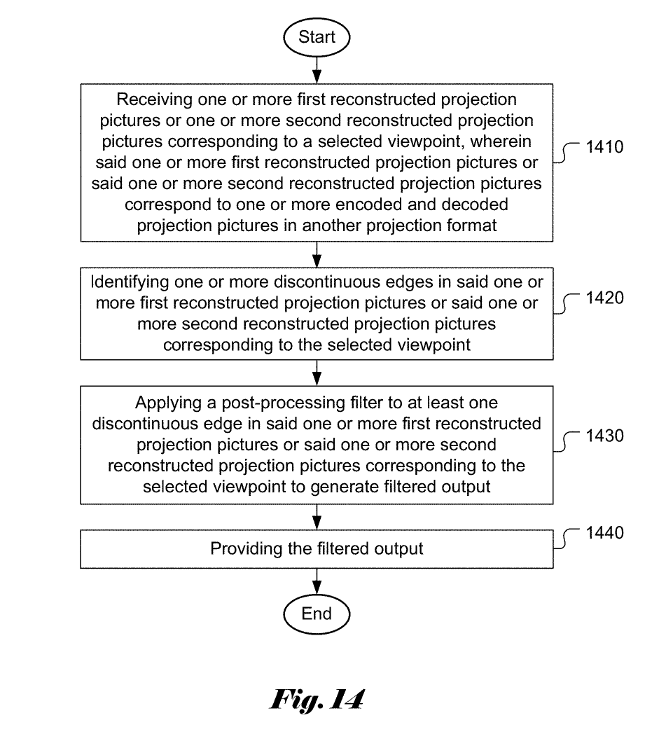

FIG. 13 illustrates an exemplary flowchart of a system that applies post-processing filter to reconstructed projection images according to an embodiment of the present invention. According to this method, one or more 360-degree virtual reality images are received in step 1310. Each 360-degree virtual reality image is projected into one first projection picture using first projection-format conversion in step 1320. One or more first projection pictures are encoded into compressed data in step 1330. The compressed data is decoded into one or more first reconstructed projection pictures in step 1340. Each first reconstructed projection picture is projected into one second reconstructed projection picture or one third reconstructed projection picture corresponding to a selected viewpoint using second projection-format conversion in step 1350. One or more discontinuous edges in one or more second reconstructed projection pictures or one or more third reconstructed projection pictures corresponding to the selected viewpoint are identified in step 1360. A post-processing filter is applied to at least one discontinuous edge in said one or more second reconstructed projection pictures or said one or more third reconstructed projection pictures corresponding to the selected viewpoint to generate filtered output in step 1370. The filtered output is then provided in step 1380.

FIG. 14 illustrates another exemplary flowchart of a system that applies post-processing filter to reconstructed projection images according to an embodiment of the present invention. The system in FIG. 14 is similar to the system in FIG. 13 except that neither first projection-format conversion nor encoding/decoding is performed. According to this method, one or more first reconstructed projection pictures or one or more second reconstructed projection pictures corresponding to a selected viewpoint are received in step 1410, where said one or more first reconstructed projection pictures or said one or more second reconstructed projection pictures correspond to one or more encoded and decoded projection pictures in another projection format. One or more discontinuous edges in said one or more first reconstructed projection pictures or said one or more second reconstructed projection pictures corresponding to the selected viewpoint are identified in step 1420. A post-processing filter is applied to at least one discontinuous edge in said one or more first reconstructed projection pictures or said one or more second reconstructed projection pictures corresponding to the selected viewpoint to generate filtered output in step 1430. The filtered output is then provided in step 1440.

The flowcharts shown above are intended for serving as examples to illustrate embodiments of the present invention. A person skilled in the art may practice the present invention by modifying individual steps, splitting or combining steps with departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of processing 360-degree virtual reality images, the method comprising:
receiving one or more 360-degree virtual reality images;
projecting each 360-degree virtual reality image into one first projection picture using first projection-format conversion;
encoding one or more first projection pictures into compressed data;
decoding the compressed data into one or more first reconstructed projection pictures;
projecting each first reconstructed projection picture into one second reconstructed projection picture or one third reconstructed projection picture corresponding to a selected viewpoint using second projection-format conversion;
identifying one or more discontinuous edges in one or more second reconstructed projection pictures or one or more third reconstructed projection pictures corresponding to the selected viewpoint;
applying a post-processing filter to at least one discontinuous edge in said one or more second reconstructed projection pictures or said one or more third reconstructed projection pictures corresponding to the selected viewpoint to generate filtered output; and
providing the filtered output.

2. The method of claim 1, wherein the post-processing filter belongs to a group comprising low-pass filter, mean filter, deblocking filter, non-local mean filter, convolutional neural network (CNN), and deep learning filter.

3. The method of claim 1, wherein said one or more 360-degree virtual reality images are in an ERP (Equirectangular Projection) format.

4. The method of claim 1, wherein the first projection-format conversion belongs to a group comprising ERP (Equirectangular Projection), CMP (Cubemap Projection), OHP (Octahedron Projection), ISP (Icosahedron Projection), SSP (Segmented Sphere Projection) and identity conversion.

5. The method of claim 4, wherein when the first projection-format conversion corresponds to the ERP, said at least one discontinuous edge is associated with a left boundary and a right boundary of one first reconstructed projection picture.

6. The method of claim 4, wherein when the first projection-format conversion corresponds to the CMP, OHP or ISP, said at least one discontinuous edge is associated with a shared face edge on a respective cube, octahedron or icosahedron in one first reconstructed projection picture and the shared face edge is projected to different edges in said one first reconstructed projection picture.

7. The method of claim 4, wherein when the first projection-format conversion corresponds to the SSP, said at least one discontinuous edge is associated with picture boundary between a north-pole image and an equatorial segment image or between a south-pole image and the equatorial segment image in one first reconstructed projection picture.

8. The method of claim 1, wherein the second projection-format conversion belongs to a group comprising ERP (Equirectangular Projection), CMP (Cubemap Projection), OHP (Octahedron Projection), ISP (Icosahedron Projection), and SSP (Segmented Sphere Projection).

9. The method of claim 1, wherein the first projection-format conversion and the second projection-format conversion correspond to RSP (Rotated Sphere Projection), and wherein said at least one discontinuous edge is associated with boundaries around a middle 270°×90° region and a residual part of one RSP picture.

10. An apparatus for processing 360-degree virtual reality images, the apparatus comprising one or more electronic devices or processors configured to:
receive one or more 360-degree virtual reality images;
project each 360-degree virtual reality image into one first projection picture using first projection-format conversion;
encode one or more first projection pictures into compressed data;
decoding the compressed data into one or more first reconstructed projection pictures;
project each first reconstructed projection picture into one second reconstructed projection picture or one third reconstructed projection picture corresponding to a selected viewpoint using second projection-format conversion;
identify one or more discontinuous edges in one or more second reconstructed projection pictures or one or more third reconstructed projection pictures corresponding to the selected viewpoint;
apply a post-processing filter to at least one discontinuous edge in said one or more second reconstructed projection pictures or said one or more third reconstructed projection pictures corresponding to the selected viewpoint to generate filtered output; and
provide the filtered output.

11. A method of processing 360-degree virtual reality images, the method comprising:
receiving one or more first reconstructed projection pictures or one or more second reconstructed projection pictures corresponding to a selected viewpoint, wherein said one or more first reconstructed projection pictures or said one or more second reconstructed projection pictures correspond to one or more encoded and decoded projection pictures in another projection format;
identifying one or more discontinuous edges in said one or more first reconstructed projection pictures or said one or more second reconstructed projection pictures corresponding to the selected viewpoint;
applying a post-processing filter to at least one discontinuous edge in said one or more first reconstructed projection pictures or said one or more second reconstructed projection pictures corresponding to the selected viewpoint to generate filtered output; and
providing the filtered output.

12. The method of claim 11, wherein the post-processing filter belongs to a group comprising low-pass filter, mean filter, deblocking filter, non-local mean filter, convolutional neural network (CNN), and deep learning filter.

13. The method of claim 11, wherein said another projection format is generated using projection-format conversion belongs to a group comprising ERP (Equirectangular Projection), CMP (Cubemap Projection), OHP (Octahedron Projection), ISP (Icosahedron Projection), SSP (Segmented Sphere Projection) and identity conversion.

14. The method of claim 13, wherein when the projection-format conversion corresponds to the ERP, said at least one discontinuous edge is associated with a left boundary and a right boundary of one encoded and decoded projection picture in another projection format.

15. The method of claim 13, wherein when the projection-format conversion corresponds to the CMP, OHP or ISP, said at least one discontinuous edge is associated with a shared face edge on a respective cube, octahedron or icosahedron in one encoded and decoded projection picture in another projection format and the shared face edge is projected to different edges in said one encoded and decoded projection picture in another projection format.

16. The method of claim 13, wherein when the projection-format conversion corresponds to the SSP, said at least one discontinuous edge is associated with picture boundary between a north-pole image and an equatorial segment image or between a south-pole image and the equatorial segment image in said one encoded and decoded projection picture in another projection format.

17. The method of claim 11, wherein said one or more encoded and decoded projection pictures in another projection format are converted into said one or more first reconstructed projection pictures or said one or more second reconstructed projection pictures corresponding to the selected viewpoint using second projection-format conversion.

18. The method of claim 17, wherein the second projection-format conversion belongs to a group comprising ERP (Equirectangular Projection), CMP (Cubemap Projection), OHP (Octahedron Projection), ISP (Icosahedron Projection), and SSP (Segmented Sphere Projection).

19. The method of claim 11, wherein said another projection format is generated using projection-format conversion corresponding to RSP (Rotated Sphere Projection), and wherein said at least one discontinuous edge is associated with boundaries around a middle 270°×90° region and a residual part of one RSP picture.

20. An apparatus for processing 360-degree virtual reality images, the apparatus comprising one or more electronic devices or processors configured to:
receive one or more first reconstructed projection pictures or one or more second reconstructed projection pictures corresponding to a selected viewpoint, wherein said one or more first reconstructed projection pictures or said one or more second reconstructed projection pictures correspond to one or more encoded and decoded projection pictures in another projection format;
identify one or more discontinuous edges in said one or more first reconstructed projection pictures or said one or more second reconstructed projection pictures corresponding to the selected viewpoint;
apply a post-processing filter to at least one discontinuous edge in said one or more first reconstructed projection pictures or said one or more second reconstructed projection pictures corresponding to the selected viewpoint to generate filtered output; and
provide the filtered output.
